(19) United States
(12) Patent Application Publication
(10) Pub. No.: US 2016/0079821 A1
(43) Pub. Date: Mar. 17, 2016

(54) ROTOR OF AN ELECTRIC MACHINE HAVING A SQUIRREL CAGE PRODUCED FROM A GRANULATE

(71) Applicant: SIEMENS AKTIENGESELLSCHAFT, München (DE)

(72) Inventor: ANDREAS BETHGE, Berlin (DE)

(73) Assignee: SIEMENS AKTIENGESELLSCHAFT, 80333 München (DE)

(21) Appl. No.: 14/787,690

(22) PCT Filed: Feb. 28, 2014
(86) PCT No.: PCT/EP2014/053959

§ 371 Date: Oct. 28, 2015

(30) Foreign Application Priority Data
Apr. 29, 2013 (EP) 13165691.0

(51) Int. Cl. H02K 3/02; H02K 17/16; H02K 15/00

(52) U.S. Cl. CPC H02K 3/02; H02K 15/0012; H02K 17/165

(57) ABSTRACT

A rotor has a rotor core which is made of a core material and has grooves which extend substantially in a direction of a rotor axis. The rotor core has at each axial end of the grooves an annular recess which is disposed concentrically with respect to the rotor axis and connects the grooves. The rotor core has a diffusion layer which has a diffusion material and which at least partially covers at least the respective surface of the grooves and/or the annular recess. A granulate of an electrically conductive material is introduced into the grooves and/or the annular recess and, while heat being supplied and while pressure being exerted, is connected by cohesive bonding to the rotor core.

The invention relates to a method for producing a rotor of an electric machine, wherein the rotor has a rotor core which is made of a core material and is disposed concentrically with respect to the rotor axis, wherein the rotor core has grooves which extend substantially in the axial direction, wherein the rotor core has at each axial end of the grooves a respective annular recess which is disposed concentrically with respect to the rotor axis and connects the grooves, wherein the rotor core has a diffusion layer which comprises a diffusion material and which at least partially covers at least the respective surface of the grooves and/or the respective annular recess.

The invention further relates to a rotor for an electric machine, wherein the rotor has a rotor core which is made of a core material and is disposed concentrically with respect to the rotor axis, wherein the rotor core has grooves which extend substantially in the axial direction, wherein the rotor core has at each axial end of the grooves a respective annular recess which is disposed concentrically with respect to the rotor axis and connects the grooves, wherein the rotor core has a diffusion layer which comprises a diffusion material and which at least partially covers at least the respective surface of the grooves and/or the respective annular recess.

Finally the invention relates to an electric machine with an inventive rotor.

Such rotors are known for example as massive asynchronous rotors, which are suitable for speeds greater than 4000 rpm and outputs in excess of 1 MW. Such massive asynchronous rotors, because of centrifugal force loads and for example because of their behavior when heated up and during vibrations for example, must satisfy high mechanical demands.

Previously, using copper parts produced individually beforehand, which were subsequently also nickel-plated and assembled into a squirrel cage, the raw cage was inserted into the shaft grooves, encapsulated in a vacuum-tight manner and connected by diffusion welding during hot isostatic pressing (HIP) by a force fit within the cage and to the steel shaft. The squirrel cage bars and ring shapes in this case are subject to the restriction that they must be able to be inserted in the radial direction and in the axial direction into the milled or turned shaft grooves. Both the parts of the squirrel cage and also the steel shaft are produced with high demands as regards an exact fit and with many test steps.

A method of this type and a rotor of this type are known for example from WO 2005/124973 A1, in which a squirrel cage, consisting of cage bars and two cage rings made of copper, is attached by means of hot isostatic pressing (HIP) to a core shaft of the rotor. To this end the core shaft or the respective element of the squirrel cage is provided with a diffusion layer at the point at which the squirrel cage is connected to the core shaft.

The underlying object of the invention is to improve the method mentioned at the start or the rotor mentioned at the start to the extent that the rotor can be produced at lower cost and has improved mechanical characteristics when the inventive method is used.

This object is achieved, for a method of the type mentioned at the start, by a granulate of an electrically-conductive material being introduced into the grooves and/or the respective annular recess, said granulate being connected to the rotor core by a material-to-material bond while heat is being supplied and pressure is being exerted.

This object is further achieved, for a rotor of the type mentioned at the start, by an electrically-conductive material being introduced into the grooves and/or the respective annular recess, which is connected by a material-to-material bond to the rotor core as a granulate while heat is being supplied and pressure is being exerted.

Finally this object is achieved by an electric machine with an inventive rotor.

In these cases the granulate has a plurality of small, solid particles such as grains or pellets of the electrically-conductive material and is also referred to as bulk material.

The diffusion material of the diffusion layer can especially be applied galvanically. Preferably the diffusion material covers the rotor core at least in that area in which the electrically-conductive material of the squirrel cage is to be connected to the rotor core. It is also conceivable for the complete rotor core to be covered by the diffusion material. Application of the diffusion material to the rotor core, which is able to be done technically without any great effort and at no great cost, makes it possible in this case to save on a technically more complex application of the diffusion material to the squirrel cage.

During the supply of heat and the exertion of pressure the diffusion layer has the effect of diffusing the diffusion material on the one hand into the core material and on the other hand into the granulate of the electrically-conductive material, so that a stable, material-to-material bond between the core material and the electrically-conductive material of the squirrel cage formed from the granulate is guaranteed.

The material-to-material bond between the granulate disposed in the grooves and/or the respective annular recess and the rotor core is achieved in such cases by hot isostatic pressing. An enclosure can be attached to the rotor core for this purpose for example, which can enclose at least the grooves and/or the respective annular recess as a gas-tight enclosure, wherein the granulate is introduced at least into the grooves and/or the respective annular recess and subsequently the enclosure is closed off gas-tight around the rotor core and evacuated. The enclosure can be, for example, a metal tube which encloses the rotor and is arranged concentrically with respect to the rotor axis. The metal tube in this case is merely an auxiliary device, which is removed after the HIP process during re-shaping of the rotor, i.e. when removing the burrs of the rotor and such like by means of turning. Preferably an excess of the granulate of the electrically-conductive material is introduced into the enclosure.

Compared to production processes in which the parts of the squirrel cage are produced beforehand and subsequently attached to the rotor, the inventive method allows the cost-intensive and time-intensive effort of producing the parts of the squirrel cage in advance to be saved completely. Costs can be saved by parts of the squirrel cage, especially molded copper parts, which have to be produced with an especially highly-accurate fit and thus have to be produced with comparatively small tolerances and consequently are comparatively expensive, not being needed any more. The high logistical demands relating to the procurement of the specially-adapted parts can also be dispensed with entirely. An additional factor is that the granulate is obtainable at comparatively low cost and can be stored and transported in large quantities. Furthermore, with the inventive method, there are now no restrictions in respect of the geometry of the individual cage parts, such as for example the rod shape and the shape of the short-circuit ring.

Instead a rotor can be produced by the inventive method which, because of the extremely good connection between the electrically-conductive material located in the grooves and the respective annular recess and the core material, has a high mechanical strength. Furthermore the inventive rotor has a very good level of electrical efficiency, since the squirrel cage is formed from electrically-conductive material connected by a material-to-material bond and not as previously by separate squirrel cage bars and rings, the connection of which has previously led to higher electrical losses. Thus, in accordance with the invention, forms of groove can also be implemented which make electrical and/or mechanical optimizations possible.

The inventive rotor is especially suitable for high speeds, since the inventive method brings about an especially strong connection between the squirrel cage produced on the basis of the granulate and the rotor core and the rotor, even when very high centrifugal forces occur, preserves its mechanical stability and integrity.

Optionally the rotor with the rotor shaft and the electrically-conductive material connected by a material-to-material bond to the rotor shaft can be partly covered by a protective layer, wherein the protective layer is attached to the rotor shaft by deposition welding. Corrosion-resistant nickel-based alloys can be used for the protective layer for example, such as Inconel. The protective layer is especially of advantage with rotors which are operated in aggressive environmental conditions. Such conditions are present for example in a drive motor of a compressor which compresses natural gas containing hydrogen sulfide for example and simultaneously uses this gas for cooling the drive motor.

The grooves can be disposed along the axial direction in the rotor core and can thus be aligned coaxially with the rotor axis. It is also conceivable for the grooves to be arranged along a helical track around the rotor axis, so that the position of the respective groove in the circumferential direction varies in the axial direction.

Preferably the granulate is introduced both into the grooves and into the respective annular recess, wherein the diffusion layer covers the grooves and the respective annular recess at least partly.

In an advantageous embodiment of the invention the electrically-conductive material includes at least copper, wherein the diffusion material includes at least nickel. Copper exhibits good electrical conductivity and is also obtainable at low cost, especially in the form of a granulate. Nickel is a material which can diffuse well into the copper granulate. Furthermore nickel is advantageous since steel is usually used for the core material and nickel has the further characteristic that it can also diffuse well into steel. Thus an especially stable material-to-material bond connecting the copper of the squirrel cage to the rotor core is achieved.

In a further advantageous embodiment of the invention the granulate, for the material-to-material bond to the rotor core is heated in this case to a temperature of 1010° C. to 1060° C., especially to 1030° C. to 1040° C., and put under a pressure of 950 bar to 1050 bar, especially 1000 bar. A durable connection between the granulate and the rotor core can be achieved if the granulate and if necessary that surface of the rotor core to which the granulate is to be connected is heated to a temperature in the said temperature range and simultaneously pressure in the said pressure range is exerted. In such cases the best results can be obtained when the temperature lies in the range of 1030° C. to 1040° C. and the pressure amounts to around 1000 bar. Good results are able to be achieved when the temperature is just, especially 3-5%, below the melting temperature of the electrically-conductive material and comparatively high pressure, especially above-800 bar, is applied.

In a further advantageous embodiment of the invention the granulate disposed in the grooves and in the respective annular recess is held in a vacuum while heat is being supplied and pressure is being exerted. The vacuum prevents the oxidization of the electrically-conductive material, wherein for the same purpose or simultaneously a process gas in the form of a protective gas or process gas can be used. Such a gas can be Argon or Nitrogen for example.

In a further advantageous embodiment of the invention the diffusion layer has a layer thickness of 1 μm to 100 μm, especially 15 μm to 40 μm. Such a layer thickness guarantees a sufficient quantity of diffusion material for a material-to-material bond between the rotor core and the squirrel cage produced from the granulate. For example the diffusion layer can be applied galvanically in such cases to the rotor core or to at least those sections of the rotor core which are to be connected to the squirrel cage.

In a further advantageous embodiment of the invention the grooves of the rotor core are embodied closed. The closed grooves are thus designed as channels in the inside of the rotor core. The inventive method also enables such closed grooves to be provided with squirrel cage bars which are formed in accordance with the invention by the granulate and are connected to the rotor core by a material-to-material bond.

Regardless of whether the grooves are embodied closed, i.e. inside the rotor core, or open, i.e. on the outer surface of the rotor core, the grooves can have an essentially rectangular, trapezoidal, triangular, round or other cross section in such cases. This is because, regardless of the shape of the grooves, a good material-to-material bond between the squirrel cage formed from the granulate and the rotor core is always guaranteed with the inventive method. Furthermore the respective annular recess can also have any given cross section, for example an essentially rectangular, trapezoidal, triangular, or round cross section. It is also conceivable to embody the respective annular recess in a conical shape.

Overall the inventive method thus makes it possible to optimize the electrical and/or mechanical characteristics of the rotor, in that the shape of the squirrel cage can be selected so that especially advantageous or desired characteristics can be achieved. The desired shape of the squirrel cage rotor can be obtained by the appropriate embodiment of the grooves and/or of the respective annular recess. If the grooves and the respective annular recess taper radially outwards for example, or especially if the grooves are embodied closed, an especially stable rotor is thus produced which is suitable for especially high speeds.

The inventive rotor can be designed for example as a massive asynchronous rotor and/or used in an electric machine. In such cases the electric machine can be able to be operated with an output of more than 1 MW and/or at a speed of more than 4000 revolutions per minute. In particular the electric machine can be designed as a drive for a mill or a compressor.

The invention is described and explained in greater detail below with reference to the exemplary embodiments shown in the figures, in which:

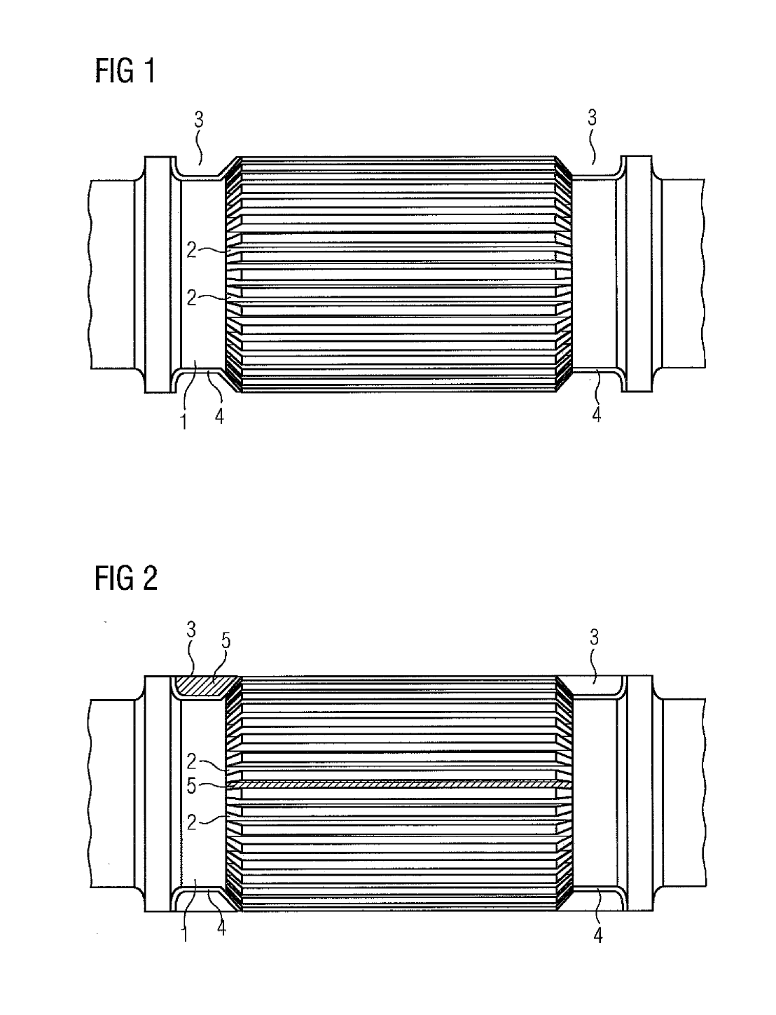

FIG. 1 shows a rotor core for producing an exemplary embodiment of an inventive rotor, and

FIG. 2 shows an exemplary embodiment of an inventive rotor

FIG. 1 shows a rotor core 1 for producing an exemplary embodiment of an inventive rotor. Grooves 2, which extend essentially in the axial direction, are inserted into the rotor core 1. The grooves 2 can be designed open and can have an essentially rectangular cross-section, as in the present exemplary embodiment. At the respective axial end of the grooves 2 the rotor 1 has an annular recess 3 disposed concentrically to the rotor axis.

It is conceivable here for the grooves 2 to have an alternate cross-section, such as the shape of a triangle, a trapezium tapering outwards or inwards, a circle or the like. Furthermore the grooves 2 can also be embodied closed with such a cross-section, so that the grooves 2 extend between the respective annular recesses 3 inside the rotor core 1. The grooves 2 can also extend precisely in the axial direction or be disposed along a helical path around the rotor axis, so that the position of the respective groove 2 in the circumferential direction varies in the axial direction. Finally the respective annular recess 3 can likewise have any given cross-section, for example an essentially rectangular, trapezoidal, triangular, or round cross section. The respective annular recess 3 can also be embodied in a cone shape for example. This allows a squirrel cage to be formed in the grooves 2 and in the respective annular recess 3 to be embodied such that the rotor has especially advantageous electrical and/or mechanical characteristics.

The rotor core 1 is particularly suited for producing a massive asynchronous rotor, which is able to be operated with an output of more than 1 MW and/or at a speed of more than 4000 revolutions per minute.

The rotor core 1 has a diffusion layer 4 which, within the context of the exemplary embodiment, covers the outer surface of the rotor core 1 in the area of the respective annular recess 3. The diffusion layer 4 in this case comprises a diffusion material, such as nickel for example, and is especially between 15 μm and 40 μm thick.

FIG. 2 shows an exemplary embodiment of an inventive rotor. The rotor shown in FIG. 2 can especially be obtained by using the rotor core 1 shown in FIG. 1 as its starting point. To this end a granulate 5 of an electrically-conductive material is introduced into the grooves 4 and the respective annular recess 3, which, for the purposes of improved clarity, is indicated in FIG. 2 for only one groove 2 and for only one section of an annular recess 3. The granulate 5 disposed in the grooves 2 and the respective annular recess 3 is then connected to the rotor core, with the supply of heat and the exertion of pressure, by a material-to-material bond. Through this process the electrically-conductive material, which is initially present as a granulate 5, forms a squirrel cage, which has squirrel cage bars in the grooves and a squirrel cage ring in the respective annular recess 3.

For a material-to-material bond connecting the granulate 5 to the rotor core 1 an enclosure can first be attached to the rotor core, which can make a gas-tight enclosure around at least the grooves 2 and the respective annular recess 3 of the rotor core 1. In this case the granulate 5 is introduced at least into the grooves 2 and the respective annular recess 3 and subsequently the enclosure is closed gas-tight around the rotor core 1 and evacuated. The enclosure can be a metal tube for example, which encloses the rotor and is disposed concentric to the rotor axis. Preferably an excess of the granulate of the electrically-conductive material is introduced into the enclosure.

The electrically-conductive material can include copper for example. Preferably the granulate 5 is heated in this case to a temperature of 1020° C. to 1050° C. and is subjected to a pressure of between 980 bar and 1020 bar. Furthermore the granulate 5 can be held in a vacuum and/or a protective gas or process gas, such as Argon or Nitrogen for example, can be supplied.

In summary the invention relates to a method for producing a rotor of an electric machine, wherein the rotor has a rotor core which is made of a core material and is disposed concentrically with respect to the rotor axis, wherein the rotor core has grooves which extend substantially in the axial direction, wherein the rotor core has at each axial end of the grooves a respective annular recess which is disposed concentrically with respect to the rotor axis and connects the grooves, wherein the rotor core has a diffusion layer which comprises a diffusion material and which at least partially covers at least the respective surface of the grooves and/or the respective annular recess. Furthermore the invention relates to such a rotor and to an electric machine with such a rotor. In order to improve the method mentioned at the start or the rotor mentioned at the start to the extent that the rotor can be produced at lower cost and, when produced in this way, has improved mechanical characteristics, it is proposed that a granulate of an electrically-conductive material, which when heat is supplied and pressure is exerted, is connected by a material-to-material bond to the rotor core, is introduced into the grooves and/or the respective annular recess.

1.-12. (canceled)

13. A method for producing a rotor of an electric machine, comprising the steps of:
making a rotor core of a core material;
providing grooves in the rotor core substantially in a direction of a rotor axis of the rotor core;
forming an annular recess at each axial end of the grooves of the rotor core in concentric relationship to the rotor axis to connect the grooves;
providing the rotor core with a diffusion layer which comprises a diffusion material and which at least partially covers at least a surface of the grooves and/or the annular recess;
introducing a granulate made of an electrically-conductive material into the grooves and/or the annular recess; and
connecting the granulate, when exposed to heat and to pressure, to the rotor core by a material-to-material bond.

14. The method of claim 13, wherein the electrically-conductive material includes at least copper, said diffusion material including at least nickel.

15. The method of claim 13, wherein the connecting step includes the step of heating the granulate to a temperature of 1010° C. to 1060° C. and subjecting the granulate to a pressure of 950 bar to 1050 bar.

16. The method of claim 15, further comprising the step of holding the granulate disposed in the grooves and/or annular recess in a vacuum while being heated and subjected to the pressure.

17. The method of claim 13, wherein the diffusion layer has a layer thickness of 1 μm to 100 μm.

18. The method of claim 13, wherein the grooves in the rotor core have a closed configuration.

19. A rotor for an electric machine, comprising:
a rotor core made of a core material and disposed in concentric relationship to a rotor axis, said rotor core having grooves, which extend substantially in a direction of the rotor axis, and an annular recess at each axial end of the grooves in concentric-relationship to the rotor axis to connect the grooves;
a diffusion layer applied on the rotor core and comprising a diffusion material, said diffusion layer configured to at least partially cover at least a surface of the grooves and/or the annular recess; and
a granulate made of electrically-conductive material and introduced into the grooves and/or the annular recess, said granulate being configured to connect to the rotor core by a material-to-material bond, when being heated and subjected to pressure.

20. The rotor of claim 19, wherein the electrically-conductive material includes at least copper, said diffusion material including at least nickel.

21. The rotor of claim 19, wherein the grooves in the rotor core have a closed configuration.

22. The rotor of claim 19, wherein the rotor is embodied as a massive asynchronous rotor.

23. An electric machine, comprising a rotor which includes a rotor core made of a core material and disposed in concentric relationship to a rotor axis, said rotor core having grooves, which extend substantially in a direction of the rotor axis, and an annular recess at each axial end of the grooves in concentric relationship to the rotor axis to connect the grooves, a diffusion layer applied on the rotor core and comprising a diffusion material, said diffusion layer configured to at least partially cover at least a surface of the grooves and/or the annular recess, and a granulate made of electrically-conductive material and introduced into the grooves and/or the annular recess, said granulate being configured to connect to the rotor core by a material-to-material bond, when being heated and subjected to pressure.

24. The electric machine of claim 23, wherein the electrically-conductive material includes at least copper, said diffusion material including at least nickel.

25. The electric machine of claim 23, wherein the grooves in the rotor core have a closed configuration.

26. The electric machine of claim 23, wherein the rotor is embodied as a massive asynchronous rotor.

27. The electric machine of claim 23, constructed for operation with an output of more than 1 MW and/or at a speed of more than 4000 revolutions per minute.
